(19) United States
(12) Patent Application Publication
(10) Pub. No.: US 2014/0278512 A1
(43) Pub. Date: Sep. 18, 2014

(54) HEALTHCARE CLAIM EDITING SYSTEM, METHOD, AND APPARATUS

(71) Applicant: ADP, Inc., Roseland, NJ (US)

(72) Inventors: James Troy Young, Draper, UT (US); Travis Don De Angelis, Murray, UT (US); Erin LouAnn Azar, Sandy, UT (US); Wendy Aiken, South Jordan, UT (US)

(73) Assignee: ADP, Inc., Roseland, NJ (US)

(21) Appl. No.: 14/216,977

(22) Filed: Mar. 17, 2014

Related U.S. Application Data
(60) Provisional application No. 61/794,233, filed on Mar. 15, 2013.

(51) Int. Cl. G06Q 50/22; G06Q 10/10

(52) U.S. Cl. CPC G06Q 50/22; G06Q 10/10
USPC 705/2

(57) ABSTRACT

A medical claim processing system and method comprising generating default rules and custom rules for inspecting healthcare claims, the default rules having general application to every healthcare claim and the custom rules being created to inspect specific requirements imposed by an insurance company or imposed to a medical code; receiving claim information related to a medical service from a healthcare provider; generating healthcare claims based on the received claim information; and inspecting the medical claims according to the default rules and the custom rules.

### RELATED APPLICATIONS

The present application claims benefits to Provisional Application No. 61/794,233, titled “Healthcare Custom Claim Editing System and Method” and filed on Mar. 15, 2013, the entirety of which is incorporated herein by reference.

### BACKGROUND

1. Field of the Present Disclosure

This present application relates generally to a system, method, and apparatus for healthcare insurance claim processing. Specifically, the present application discloses a system, method, and apparatus for custom insurance claim editing of healthcare claims according to custom claim editing rules.

2. Background Discussion

The average U.S. physician spends 43 minutes a day interacting with health plans about payment, dealing with formularies, and obtaining authorizations for procedures. In addition, physicians' offices also hire coders, who spend their days translating clinical records into billing forms and submitting and monitoring reimbursements. These administrative costs especially those related to insurance have put noticeable burdens on physician's time and resource, which should be spent on their core service, such as medical treatment and diagnosis. On a systematic level, the United States spends $361 billion annually on health care administration, which is more than twice the total spending on heart disease and three times the spending on cancer, according to a report of the Institute of Medicine (“10M”).

Another finding according to IOM is that about half of these expenditures are unnecessary. For example, a major portion of administrative costs are billing and insurance-related (“BIR”) activities undertaken to fulfill the requirements of getting paid by insurance companies or by collection agencies. Most BIR activities occur at the provider or physician level, with a smaller amount at the payer or insurer level. Although BIR activities reflect the transaction cost of a complex payment system, it largely constitutes inefficiency rather than added value.

A particular burden in the medical billing administration is the medical claim or healthcare insurance claim processing. Unlike the general perception of medical billing being just claim submission and realization, medical billing has grown to be an arduous task for the practicing physicians, clinics, and multi-specialty hospitals. In a typical scenario, after a patient leaves a physician's office, the physician, in order to obtain payment from an insurance company, would need to create a medical claim with the correct medical coding, timely submit the claim to the insurance company, verify any payment from the insurance company, dispute any denied amount, file an appeal to the insurance company, and prepare a secondary billing for any unpaid amount. These administrative tasks are not only time consuming but also complex to handle, given the fact that there are many insurance companies each with various insurance contracts each having their own exceptions or specific requirements for claim submission and payment. For example, different insurers may have various claim forms, formats, or codes, that must be completed accurately for claim submissions to be paid.

While physicians have tried to free themselves by hiring in-house medical billing staffs, the results are not satisfying due to the diverse healthcare service they provide and the complex requirements on claim forms and substance by insurance companies. Based on an industry wide statistics, approximately 14% of all claims submitted to the payors are denied and have to be either resubmitted, appealed, or written off by providers. Approximately 50% of denied claims are never re-filed.

### SUMMARY OF THE INVENTION

There is a strong and long-felt need in the healthcare industry to reduce the administrative cost occurred at the side of healthcare providers. Specifically, there is a strong and long-felt need to streamline the medical or healthcare claim processing for healthcare providers so that they can spend more time and resource on their core practice: medical diagnosis and treatment. An objective of the present application is to empower healthcare providers with the ability to create their own claim edit inspection criteria to identify and correct errors and/or omissions before claims are submitted to a payer or an insurance carrier. An objective of the present application is to provide such customized claim edits at a carrier level.

According to some implementations of the present application, the problem of generating and processing medical claims in compliance with various statutory and payor requirements is solved by a computer assisted claim processing method and apparatus that allow a user to create custom claim inspection rules, in addition to default rules, based on a plurality of criteria including: current procedural code (“CPT”): a particular payer: or a particular category of codes and/or carriers. The claim processing system and method will use the custom claim inspection rules to review claims after a healthcare provider inputs relevant claim information. In a situation where a healthcare provider prefers to input claims in batches, the system and method will not inspect those claims until the healthcare provider finishes inputting the entire batch. The invention of the present application allows healthcare providers to increase staff efficiency, streamline claims billing processes, increase the percentage of clean claims submitted, reduce the number of claims denied, and receive payment from the health insurer (payor) in a timely and accurate manner, thus reduce the revenue loss of a healthcare provider.

According to an aspect, the present application is directed to a healthcare claim processing method comprising generating default rules and custom rules for inspecting healthcare claims, the default rules having general application to every healthcare claim and the custom rules being created to inspect specific requirements imposed by an insurance company or imposed to a medical code; receiving claim information related to a medical service from a healthcare provider; generating healthcare claims based on the received claim information; and inspecting the medical claims according to the default rules and the custom rules.

According to an embodiment of the present application, the healthcare claim processing method further comprises displaying an error message to the healthcare provider when the healthcare claim violates the custom rules.

According to some embodiments of the present application, the healthcare claim processing method generates a custom rule for a medical code that requires a modifier or exception for a category of medical code that requires a modifier or exception, for a particular insurance carrier, or for a category of insurance carriers.

According to yet another embodiment of the present application, the receiving step receives claim information in batches and the inspecting step inspects the generated claims after the input of the entire batch of claim information is finished.

According to yet another embodiment of the present application, the healthcare claim processing method further comprises providing an option to the healthcare provider to turn a custom rule on or off.

According to an aspect, the present application is directed to a recording medium storing an executable program, when executed, causing a processor to execute the healthcare claim processing method as described in the present application.

According to an aspect, the present application is directed to a healthcare claim processing system comprising an electronic device that transmits claim information from a healthcare provider to a billing service device. The billing service device generates default rules and custom rules for inspecting healthcare claims, the default rules having general application to every healthcare claim and the custom rules being created to inspect specific requirements imposed by an insurance company or imposed to a medical code; receiving claim information related to a medical service from a healthcare provider; generating healthcare claims based on the received claim information; and inspecting the medical claims according to the default rules and the custom rules.

According to some embodiments of the present application, the billing service device also implements the various healthcare claim processing methods as described in the present application.

### BRIEF DESCRIPTION OF DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present application is intended to include all such aspects and their equivalents. Other advantages, embodiments and novel features of the invention may become apparent from the following description of the present invention when considered in conjunction with the drawings. The following description, given by way of example, but not intended to limit the present invention solely to the specific embodiments described, may best be understood in conjunction with the accompanying drawings, in which:

FIG. 1 illustrates an embodiment of a medical claim processing system.

FIG. 2 illustrates an embodiment of an electronic device capable of being used with the medical claim processing system.

FIG. 3 illustrates functional modules of a billing service manager 300 according to an embodiment of the present application.

FIG. 4 illustrates a screen 400 for managing and/or creating a default rule according to an embodiment of the present application.

FIG. 5 illustrates a screen 500 for managing and/or creating a custom rule according to an embodiment of the present application.

FIG. 6 illustrates a screen 600 that allows a user to search custom rules in the database according to an embodiment of the present application.

FIG. 7 shows a screen 700 that has security settings for a user to control a custom edit according to an embodiment of the present application.

FIG. 8 shows a screen 800 for managing custom rules according to an embodiment of the present application.

FIG. 9 shows a screen 900 for creating a custom rule according to an embodiment of the present application.

### DETAILED DESCRIPTION

Those of ordinary skill in the art will realize that the description of the present invention is illustrative only and not in any way limiting. Other embodiments will readily suggest themselves to such skilled persons, having the benefit of this disclosure. Reference will be made in detail to specific implementations of the present invention as illustrated in the accompanying drawings.

Further, certain figures in this specification are flow charts illustrating methods and systems. It will be understood that each block of these flow charts, and combinations of blocks in these flow charts, must be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory or a storage medium that can direct a computer or other programmable apparatus to function in a particular manner, such that the instructions stored in the computer-readable memory or storage medium produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Ruby, Python, Pascal, SmallTalk, FORTRAN, assembly language, and the like, may be used to implement aspects of the present application. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” or “storage medium” can be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, a compact flash card, a smart media cart, a SMS card, any other magnetic medium, a CD-ROM, a DVD, or any other optical medium.

FIG. 1 depicts a medical claim processing system 100 according to an embodiment of the present application. As illustrated, the medical claim processing system 100 includes a healthcare provider 110, a billing service manager 120, an insurance company 140 and a network 130. The exemplary simplified number of healthcare provider 110, billing service manager 120, insurance company 140, and networks 130 illustrated in FIG. 1 can be modified as appropriate in a particular implementation. In practice, there may be additional healthcare providers 110, billing service managers 120, insurance companies 140, and/or networks 130.

The healthcare provider 110 may include any individual or any institution that provides preventive, curative, promotional or rehabilitative health care services to individuals, families or communities. Hospitals, clinics, primary care centers, emergency rooms, trauma centers, urgent care centers, laboratories, and any other service points are known healthcare providers. A patient comes to a healthcare provider to seek consultation, diagnosis, and treatment from a healthcare practitioner, such as physicians, dentists, pharmacists, physician assistants, nurses, therapists, psychologist, chiropractors, laboratory scientists, or similar professionals. The healthcare provider ordinarily keeps a medical record of the patient either on paper or electronically, which includes patient's personal information, medical history, service rendered on site, current prescription, further appointments, and etc. When the medical record is kept electronically, it may also be know as electronic health record (“EHR”).

Upon the completion of a visit, a patient may pay for the service with his or her own resource or with insurance plans or the combination thereof. To obtain payments from insurance companies, a healthcare provider needs to file healthcare claims to the insurance company 140 who has a contract with the patient and/or the healthcare provider. A healthcare claim includes certain information that are commonly required by most insurance carriers, such as physician's name, patient's name, service date, policy number, and etc. A healthcare claim is also required to be in compliance with relevant statutory requirements such as Health Insurance Portability and Accountability Act (“HIPAA”). A healthcare claim becomes more complex when each insurance company or payer may also have its own specific requirements of a claim, which are applicable to a particular code, a category of code, a particular carrier, a category of carrier, a particular plan, a category of plan, a particular disease, a category of disease, a particular treatment, a category of treatments and/or the combination thereof.

According to an embodiment, the medical claim needs to provide a medical code such as a CPT code or ICD-10 code or a HCPCS code or an ICD 9 code according to the requirement of the insurance company 140. In some situations, an insurance company may also require additional codes or descriptions, such as a service code designated by the insurance company, together with the medical code. In some situations, an insurance company or payer may create an exception to a medical code to an entire category of medical codes. If a healthcare provider uses codes that do not conform to the insurance company's requirement in a medical claim, that claim may be denied, delayed or even ignored.

According to an embodiment, the billing service manager 120 represents an in-house service or a third party service, such as ADP's AdvancedMD™, that assists a healthcare provider 110 to process a medical claim to the insurance company 140. The billing service manager 120 may use a software install on an electronic device to handle all medical billing related tasks such as to receive input from the healthcare provider 110, generate healthcare claims, inspect the healthcare claims, edit the healthcare claims, submit the healthcare claims, verify payments, and etc. As the healthcare provider 110, the billing service manager 120, and the insurance company 140 are all connected to the network 130, the healthcare provider can access to the billing service manager from any point that have connection service to the billing service manager.

According to an embodiment, the billing service manager 120 provides a browser based interface to a user for inputting a claim. The user may use an electronic device, such as a server, a computer, a mobile phone, a tablet, a laptop, or a TV, to connect to the network and the billing service manager 120 and input the service data. The billing service manager 120 may allow the healthcare provider to install dedicated software on an electronic device and execute the software to make connections to the billing service manager 120 and input data.

In certain embodiments, the billing service manager 120 may include an electronic device connect to network 130 via wired and/or wireless connections, and thereby communicate or become coupled with healthcare provider 110 and/or the insurance company 140, either directly or indirectly. Alternatively, the billing service manager 120 may be associated with healthcare provider 110 and/or the insurance company 140 through any suitable tangible computer-readable media or data storage device (such as a disk drive, CD-ROM, DVD, or the like), data stream, file, or communication channel.

The billing service manager 120 may automatically generate claims periodically from the electronic health records maintained by the healthcare provider 110. The billing service manager 120 may also generate medical claims based on the input of a users associated with the healthcare provider 110. To reduce the odds that a claim may be denied or ignored by the insurance company 140, the billing service manager 120 inspects generated claims based on rules available to the billing service manager 120. If the medical claim is found to satisfy all the relevant rules, the medical claim may submit to the insurance company 140 immediately or at a predetermined time or based on the user's instruction. If the medical claim is in conflict with certain rules, the billing service manager 120 presents a message to the user about the conflict and/or presents the relevant part of the medical claim to the user.

According to an embodiment of the present application, the billing service manager 120 inspects generated claims based on both default rules and custom edit rules. The default rules include common rules applicable to most services. For example, a default rule may be that a healthcare claim needs to include the name of a physician or the name of the patient. The custom edit rules include specific rules designated to a limited number of situations. For example, a custom edit rule may be used for inspect of claim that is to be submitted to a specific payer or a category of payers, that has a specific medical code or the code belongs to a category of codes, that is associated with a specific type of service, and/or similar situations. The custom claim edit rules may be created by a healthcare provider, a payer, or the billing service manager upon a request from the healthcare provider and the payer. According an embodiment, the custom claim edit rules are created to address any exceptions or modifiers to a medical code as required by an insurance carrier

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

FIG. 2 is an exemplary diagram of an electronic device 200 that may be used to implement aspects of certain embodiments of the present application, such as aspects of healthcare provider 110 or of billing service manager 120 or of insurance company 140. The following examples illustrate a few implementations of the electronic device, including any desktop computer, any laptop, any server, any tablet such as iPad, any mobile phone such as iPhone, any computer device designed for a general or particular application such as Netbook, and similar devices.

The electronic device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of the electronic device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to the electronic device 200, such as a keyboard, a mouse, a pen, a stylus, handwriting recognition, touch screen display, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables the electronic device 200 to communicate with other devices and/or systems. For example, communication interface 235 may include mechanisms for communicating with another device or system via a network, such as network 130 as shown in FIG. 1.

As will be described in detail below, electronic device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present application. Thus, various implementations are not limited to any specific combination of hardware circuitry and software.

A web browser comprising a web browser user interface may be used to display information (such as textual and graphical information) on the electronic device 200. The web browser may comprise any type of visual display capable of displaying information received via the network 130 shown in FIG. 1, such as Microsoft's Internet Explorer browser, Mozilla's Firefox browser, Apple's Safari browser, Google's Chrome browser or any other commercially available or customized browsing or other application software capable of communicating with network 130. The electronic device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the electronic device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present application described herein are discussed in the context of the global data communication network commonly referred to as the Internet. Those skilled in the art will realize that embodiments of the present application may use any other suitable data communication network, including without limitation direct point-to-point data communication systems, dial-up networks, personal or corporate Intranets, proprietary networks, Cloud network, or combinations of any of these with or without connections to the Internet.

FIG. 3 illustrates functional blocks of a billing service manager 300 according to an embodiment of the present application. The billing service manager 120 includes a communication interface 302, a rule editor 312, a claim generator 304, a claim inspector 306, a claim editor 314, a default rule database 308, and a custom rule database 310. The communication interface 302 receives data from an input device of the billing service manager 300 or from another device. The communication interface 302 also transmits data to an output device such as a display of the billing service manager 300 or to another device. For example, the communication interface 302 receives input from a user via a network and transmits generated medical claims to a payer such as an insurance company also via a network. The rule editor 312 can create, retrieve, modify, and store claim inspection rules, which may be separated to default rules and custom claim edit rules. The claim generator 304 generates medical claims according to the input of the user and following the general requirement of a relevant insurance company and statutes.

The claim inspector 306 reviews the generated medical claims according to rules stored in default rule database 308 and custom rule database 310. According to an embodiment, the claim inspector 306 does not inspect any claim until a user finishes inputting of data to generate a plurality of claims. For example, when a user uses a batch input to upload data that will generate many claims, the claim inspector 306 will not inspect a claim at the moment when it is created. Rather, the claim inspector 306 starts inspecting the claims after the user finishes inputting. In this way, the user can concentrate on the data inputting task without being disturbed by any custom edits, thus enhancing efficiency.

The default rule database 308 includes rules that are commonly used by insurance carriers or rules that are routinely used before a particular time or rules that have general application to most medical claims. The custom rule database 310 includes rules that have narrower applications, such as rules corresponding to exceptions under a contract or required by an insurance carrier. According to an embodiment, the default rule database 308 and the custom rule database 310 may be combined to be a master rule database or file.

According to an embodiment of the present application, a healthcare provider who is using the billing service manager 300 is allowed to create their own claim edit inspection criteria to identify and correct errors and/or omissions before claims are submitted and rejected by insurance carriers. Special claim edits to a medical claim may be created at a carrier level. These claim edits may help reduce the number of claims being processing to the insurance company in an incorrect form or format, thus reducing the number of rejected claims and the loss of revenue.

According to an embodiment, when an insurance carrier requires a modifier to be posted with a medical code such as a CPT code, a healthcare provider is allowed by the billing service manager 300 to post large batches of charges without worrying about which carrier requires exceptions. The custom claim edits are implemented during the review and inspection of generated medical claims and before the claims are transferred to an insurance carrier. A healthcare provider may set custom edit rules to an insurance carrier, to a category of insurance carriers, to a medical code, to a category of medical codes, and/or to exceptions required by insurance carriers.

In operation, a user, who has set specific carrier requirements in custom claim edit rules or files, may enter batch charges without reviewing and editing exceptions, which allows the user to concentrate on data entry. Upon reviewing the claims, the custom claim edit rules are checked to identify any exceptions, which require further edits and attention from the user. The user is able to efficiently enter the charges and perform the review and edit process for exceptions in the claim reviewing or inspection stage. This allows the user to get no-edit charges out the door quickly and make needed changes quickly while preventing loss of revenue.

According to an embodiment, the billing service manager 300 allows a user to adjust settings on the applicability of a custom claim edit rule to an insurance carrier, a medical code, a service, or similar limitations. For example, the custom edit rules may be ignored or in applicable to all claims. Existing custom edit rules may be searched, retrieved, and reassigned to various carriers. The custom claim edit rules may also be set as default rules, which is applicable to all claims. To avoid any unauthorized adjustment of the settings, the billing service manager 300 sets a security attribute to each user to define the user's authority on revising a default rule or a custom claim edit rule. According to an embodiment, a low level user may not be able to change the rule settings so that a specific custom claim rules will not affect other clients. According to another embodiment, only a user at the administrator level or global user level or coder level is allowed to input and edit and assign custom rules. After a custom rule is input to the billing service manager 300, that rule is stored in the custom rule database 310 and other users who have authorities can search the database 310 and designates a particular rule to a specific client.

According to an embodiment, the custom claim edit rules includes rules associated with code types, a specific code, carrier category, a specific carrier, an exception/modifier required by carriers, and/or a combination thereof. Each custom claim edit rule also includes a description of the required edits by a user which informs the actions needed from the user. For example, the custom claim edit rules include a rule associated with a combination of a carrier category, a medical code, and a modifier. The custom claim edit rules may also include a rule associated with a combination of a carrier, a medical code, and modifier. If any line item created with an edit with matching carrier category or carrier or CPT does not have required modifier, the claim is identified during claim inspection or review and is presented to a user for further action.

The following list includes several exemplary combinations of carrier, medical code, and modifiers according to an embodiment of the present application:

If Carrier is Blue Cross Blue Shield with CPT code 90460 and units, stop the claims. An edit error message is presented to the user: 90460 cannot be billed to BCBS with units.

If Carrier is Blue Cross Blue Shield with CPT code 90461 and units, stop the claims. An edit error message is presented to the user: 90461 cannot be billed to BCBS with units.

For CPT codes 99391 and 99381, if the patient age is under 8 days old at the date of service and the primary service identifier (“DX”) is not V20.31, stop the claims. An edit error message is presented to the user: the primary DX for CPT 99391 or 99381 for a patient under 8 days old is V20.31.

For CPT codes 99391 and 99381, if the patient age is greater than 8 days old and less than 28 days old at the date of service and the primary service identifier (“DX”) is not V20.32, stop the claims. An edit error message is presented to the user: the primary DX for CPT 99391 or 99381 for a patient between 8 days old and 28 days old is V20.32.

For CPT codes 99391 and 99381, if the patient age is greater than 28 days old at the date of service and the primary service identifier (“DX”) is not V20.2, stop the claims. An edit error message is presented to the user: the primary DX for CPT 99391 or 99381 for a patient greater than 28 days old is V20.2.

Any CPT that has a $0 fee is stopped. An error edit message is presented to the user: Verify $0 dollar charge.

For Medicaid any charge with a 25 or 59 modifier is stopped. An edit error message is presented to the user: Medicaid does not accept modifier 25 or 59.

For CPT 99392, 99393, 99394, 993982, 99383, and 99384, if the primary service identifier (“DX”) does not equal V70.0, the claim is stopped. An edit error message is presented to the user: CPT 99392, 99393, 99394, 993982, 99383, and 99384 require primary DX V70.0.

For CPT 99395, 99396, 99385, 99386, and 99387, if the primary service identifier (“DX”) does not equal V70.0, stop the claims. An edit error message is presented to the user: CPT 99395, 99396, 99385, 99386, and 99387 requires primary DX V70.0.

For any Medicare Insurance that has CPT codes 99241, 99242, 99243, and 99245, the claims are stopped. An edit error message is presented to the user: Medicare Insurances do not accept the following consultation codes: 99241, 99242, 99243, and 99245.

FIG. 4-6 shows screens of user interfaces assisting a user to manage both default and custom claim edit rule databases according to various embodiments of the present application.

FIG. 4 shows a screen 400 for managing and/or creating a default rule according to an embodiment of the present application. The screen 400 provides a default rule menu 402 and a custom rule menu 404. The screen 400 as shown in FIG. 4 illustrates the default rule menu 402. A user by using the default rule menu 402 can create, search, and store a default rule included in the billing service manager 300. The rule number menu 404 allows the user to provide an identifier to a default rule. A user may also uses the rule number menu 404 to review and search all the default rule numbers currently available in the system. The description menu 408 allows a user to put a caption or description about the default rule. The full text menu 410 includes the actual content of the default rule. In the default rule menu 402, a user may also associate a carrier exception 412 with a default rule. When a default rule is not preferred by a user or is not ready to be used, the menu 414 allows a user to disable the rule or to tell the system to ignore this rule completely.

FIG. 5 shows a screen 500 for managing and/or creating a custom rule according to an embodiment of the present application. The carrier rule menu 502 allows a user to manage and create carrier specific or custom claim edit rules. The table 504 on the screen 500 retrieves available custom rules from the database and presents them to the user. The table 504 illustrates the rule's identifier such as a name, a carrier to whom this rule is applicable, and a category field showing whether this rule is applicable to a category of carriers. The table 506 on the right part of the screen 500 retrieves detailed information of the rule including rule name 508, description 510, associated medical code and modifier 512, and associated carrier or carrier category. A user can also use the table 506 to create and store a custom rule. The “CPT code and modifier” menu 512 allows a user to combine a particular medical code and modifier or allows the user to apply a rule to any modifier with this medical code, regardless who the carrier is. The billing service manager collects and stores all medical codes and modifier that are being used by various payers. When a user uses the “CPT code and Modifier” menu 512, the menu 512 may provide a list of CPT codes and available modifiers so that a user can make a selection out of the list. According to an embodiment, the menu 512 includes a CPT drop-down menu listing all available CPT codes and a modifier drop-down menu listing all available modifiers. The menu 514 allows a user to associated the rule with a specific carrier such as Blue Cross Blue Shield or apply this rule to all carriers. According to an embodiment, the menu 514 includes a drop-down menu listing all carriers available in the system.

FIG. 6 shows a screen 600 that allows a user to search custom rules in the database according to an embodiment of the present application. The search screen 600 includes a keyword search menu 602, which searches the custom rule database based on keyword or text input by the user. The user also has the option 604 of using the text to search a particular carrier or a category carrier. The table 604 displays the search results to the user.

FIG. 7 shows a screen 700 that has security settings for a user to control a custom edit rule according to an embodiment of the present application. The attribute 702 is designated to control whether custom edit rules are applicable or not. The attribute has a value of either “Yes” or “No.” According to an embodiment, a default value is “No,” which means that the custom edit rules are not applicable. The value of the attribute 702 is read only, which means that only authorized user such as a global user or an administrator can change its value. If the value of the attribute 702 is changed to “Yes,” then claims generated for a client will be inspected according to custom claim edit rules as disclosed in previous disclosures of the present application. The attribute 704 allows a user to adjust a time period, such as 30 days, beyond which, the billing service manager 300 will bring an unpaid claim to the attention of a healthcare provider.

FIG. 8 shows a screen 800 for managing custom rules according to an embodiment of the present application. Table 802 retrieves all custom rules based on a user's search criteria such as keyword of a carrier, rule name, or CPT code and displays the retrieved custom rules. In FIG. 8, Table 802 displays the code of the rule such as RULE01 and RULE02 and a brief description of a rule and the status of a rule such as Enabled or not. In Table 802, both RULE01 and RULE02 are enabled, which means that they will be used to inspect claims. The action menu 804 allows a user to take an action to a custom rule such as save, clear, or delete a selected rule. When a rule selected, Table 802 puts a mark on that record. For example, when RULE01 is selected, the corresponding record may be filled with a color different from the rest or may be boxed with a special frame. Also, when a rule is selected, relevant information of that rule is displayed in the lower part of the screen 800. For example, Field 806 displays the name of the rule. The check box 808 allows a user to enable or disable a rule. A user may also edit the rule if the “edit details” button is clicked. Field 810 displays a brief description of the rule, which corresponds to the description used in Table 802. Field 812 provides detailed information of a rule. For example, Field 812 displays the CPT and the Carrier associated with the rule. According to an embodiment, the contents in the Field 812 need to follow a predetermined script in order to effectively set up a custom rule.

FIG. 9 shows a screen 900 for creating a custom rule according to an embodiment of the present application. The screen 900 is used to create a custom rule. The screen 900 allows a user to add a plurality of inspection criteria to a custom rule. By using the button 908, a user can add or delete criteria. Field 902 shows the added criteria and Field 904 shows available criteria in a drop down menu. According to an embodiment, the available inspection criteria are based on carrier, CPT, primary DX, modifier, existence of unit, age, Fee, or charge code. For each criterion, the user can set a category, a plurality of subject matter, or a negative limitation to the subject matter. For example, a user can not only use “THE CARRIER IS” but also use “THE CARRIER IS NOT,” “ALL CARRIERS,” “THE CARRIER CATEGORY IS,” “THE CARRIER CATEGORY IS NOT,” “ALL CARRIER CATEGORIES,” “THE CARRIER CPID IS,” AND “THE CARRIER CPID IS NOT” as the inspection criteria. Field 906 displays the specific value corresponding to each criterion used by the user. These available values for a criterion are also displayed to the user in a drop down menu.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A healthcare claim processing method comprising:
generating default rules and custom rules for inspecting healthcare claims, the default rules having general application to every healthcare claim and the custom rules being created to inspect specific requirements imposed by an insurance company or imposed to a medical code;
receiving claim information related to a medical service from a healthcare provider;
generating healthcare claims based on the received claim information; and
inspecting the medical claims according to the default rules and the custom rules.

2. The healthcare claim processing method of claim 1 further comprising:
displaying an error message to the healthcare provider when the healthcare claim violates the custom rules.

3. The healthcare claim processing method of claim 1, wherein the rule generating step includes generating a custom rule for a medical code that requires a modifier or exception.

4. The healthcare claim processing method of claim 1, wherein the rule generating step includes generating a custom rule for a category of medical code that requires a modifier or exception.

5. The healthcare claim processing method of claim 1, wherein the rule generating step includes generating a custom rule for an insurance carrier.

6. The healthcare claim processing method of claim 1, wherein the rule generating step includes generating a custom rule for a category of insurance carriers.

7. The healthcare claim processing method of claim 1, wherein the receiving step receives claim information in batches and the inspecting step inspects the generated claims after the input of the entire batch of claim information is finished.

8. The healthcare claim processing method of claim 1, further comprising:
providing an option to the healthcare provider to turn on or off a custom rule.

9. A healthcare claim processing system comprising:
an electronic device that transmits claim information from a healthcare provider to a computerized billing service device,
wherein the computerized billing service device includes both default and custom rules for inspecting healthcare claims, the default rules having general application to every healthcare claim and the custom rules being created to inspect specific requirements imposed by an insurance company or imposed to a medical code.

10. The healthcare claim processing system of claim 9, wherein the computerized billing service device displays an error message to the healthcare provider when the healthcare claim violates the custom rules.

11. The healthcare claim processing system of claim 9, wherein the computerized billing service device further generates a custom rule for a medical code that requires a modifier or exception.

12. The healthcare claim processing system of claim 9, wherein the computerized billing service device further generates a custom rule for a category of a medical code that requires a modifier or exception.

13. The healthcare claim processing system of claim 9, wherein the computerized billing service device further generates a custom rule for an insurance carrier.

14. The healthcare claim processing system of claim 9, wherein the computerized billing service device further generates a custom rule for a category of insurance carriers.

15. The healthcare claim processing system of claim 9, wherein the computerized billing service devices receives claim information in batches and inspects the generated claims after the input of the entire batch of claim information is finished.

16. The healthcare claim processing system of claim 9, wherein the computerized billing service device provides an option to the healthcare provider to turn on or off a custom rule.

17. A recording medium storing a program, when executed, causing a processor to execute instructions according to a healthcare claim processing method, the healthcare processing method comprising:
generating default rules and custom rules for inspecting healthcare claims, the default rules having general application to every healthcare claim and the custom rules being created to inspect specific requirements imposed by an insurance company or imposed to a medical code;
receiving claim information related to a medical service from a healthcare provider;
generating healthcare claims based on the received claim information; and
inspecting the medical claims according to the default rules and the custom rules.
